(19) United States
(12) Patent Application Publication
(10) Pub. No.: US 2014/0081792 A1
(43) Pub. Date: Mar. 20, 2014

(54) Auction System and Method

(71) Applicant: Matthew Alexander Chatterton, Stanford-le-Hoper (GB)

(72) Inventor: Matthew Alexander Chatterton, Stanford-le-Hoper (GB)

(21) Appl. No.: 13/316,064

(22) Filed: Dec. 9, 2011

(30) Foreign Application Priority Data
Dec. 9, 2011 (GB) GB1020868.4

(51) Int. Cl. G06Q 30/08

(52) U.S. Cl. CPC G06Q 30/08
USPC 705/26.3

(57) ABSTRACT

A system and method for conducting an auction for an item comprising an auction server in a network such as the Internet. The item is given a target price. As each bidder bids, the amount bid is added to the sum of all earlier bids for the item made by the bidder. As a bidder makes a bid, the auction server collects the amount bid. When the total bid of a bidder exceeds the target price, the bidder wins. If the bidder does not wish to pay the higher price, the bidder is refunded the total of his bids and leaves the auction for the item. If the bidder accepts paying the higher price, the sale is completed. A bidder has the option to obtain a refund of the amount bid for the item and to leave the bidding process for the item at any stage of the bidding process.

### TECHNICAL FIELD

The present invention relates to a system and method for auctioning items over the Internet. The present invention relates to a system and method for auctioning of items over the Internet which employs a process where everybody stands to gain and where fairness is clear.

### BACKGROUND ART

Internet auctioning is well known. Perhaps the best known example is E-bay® where sellers offer up articles for sale and bidders offer bids to increase the price until a time deadline is reached, at which time the current bidder of the highest bid wins the item and is required to pay before shipping of the item can occur. Many other auction sites exist which emulate to some degree or another the E-bay model. E-bay like sites have the disadvantage that most sellers have only one item in a specific category for sale at any time, so that if an item is lost by not submitting the highest bid at the time deadline, it is known that the item is nearly always lost forever. The preset invention seeks to overcome this problem.

In an E-bay like auction, the winning bidder is required to make payment only after they have had their winning bid confirmed. There is often a problem in obtaining payment and many sellers complain of “time wasters” whose activities frequently require the seller to list the item for sale on several occasions before a proper deal can be completed. The present invention seeks to avoid these problems by providing a system and method whereby the activities of “time wasters” are discouraged and where their impact upon the overall process is negligible.

There exist a few auction-like Internet websites that I do not seem to offer the user or bidder a good deal. While each Internet website does operate on a bidding basis, their workings may be characterized as being more like a lottery or a fruit machine, taking, people's money regardless of whether they win or lose, and occasionally paying out once enough profit has been made. The present invention seeks to provide some of the excitement and interest provided by a so-called gambling website while actually providing a bidding regime which is scrupulously fair, where no one can waste money or time on the site, where no one will walk away empty handed and disappointed, and where no one will feel they have been unfairly treated or scammed out of money.

### DISCLOSURE OF THE INVENTION

According to a first aspect, the present invention consists in a system comprising an auction server for auctioning an tem and a network through which one or more bidders can make a bid for the item, the item being provided with a target price; where: the auction server comprises means automatically operable to receive a bid from a bidder; the auction server comprises means automatically operable to add the latest bid from that bidder to the sum of any earlier bids from that bidder for that item to make a total bid; and the auction server comprises means automatically operable to carry out a winners procedure for a bidder for the item when the total bid for that item made by that bidder exceeds the target price.

According to a second aspect, the present invention consists in a method of conducting an auction for an item; the method comprising the steps of: a step of setting a target price for the item; a step of automatically receiving a bid from a bidder; a step of automatically adding the latest bid from that bidder to the sum of any earlier bids from that bidder for that item to make a total bid; and a step of automatically carrying out a winners procedure for a bidder for the item when the total bid for that by that bidder item exceeds the target price.

The present invention further provides a system and method wherein the auction server can hold a current bid price for the item and can receive, as a fresh bid, only an amount which exceeds the current bid price by a predetermined amount.

The present invention further provides a system and method wherein the auction server can automatically collect the amount bid from a bidder on each occasion that the bidder places a bid for that item.

The present invention further provides a system and method wherein the auction server can respond to indication by the bidder to accept the sale even if the total bid by that bidder is greater than the target price.

The present invention further provides system and method wherein the auction server can automatically receive and respond to a request by bidder, to deliver a refund of the total bid by that bidder to that bidder.

The present invention further provides a system and method where the item can be one of a plurality of like items offered for sale at the same time and the auction server can sell each of the like items in turn until the last like item has been won.

### BRIEF DESCRIPTION OF THE DRAWINGS

The invention is further explained, by way of embodiments and examples, by the following description to be read in conjunction with the appended Claims, in which:

FIG. 1 is a schematic block diagram illustrating one environment within which the invention can function.

FIG. 2 is a schematic block diagram showing exemplary contents of an auction server of FIG. 1.

FIG. 3 is a flow chart illustrating the activity of the webmaster terminal of FIG. 1 when presenting an item for sale to the auction server 10.

FIG. 4 is an exemplary flow chart showing one example of how the auction server can handle the presentation and sale of a particular item.

FIG. 5 is a flow chart illustrating and example of one way in which a winning bidder, within the procedure of FIG. 4, can interact with the auction server either to reject or accept the winning bid nomination. and

FIG. 6 is an exemplary flowchart illustrating one way in which procedure of FIG. 4 can be implemented to enable a bidder to obtain a refund of the total amount bid at any stage during the course of an auction for an item.

### BEST MODE FOR CARRYING OUT THE INVENTION

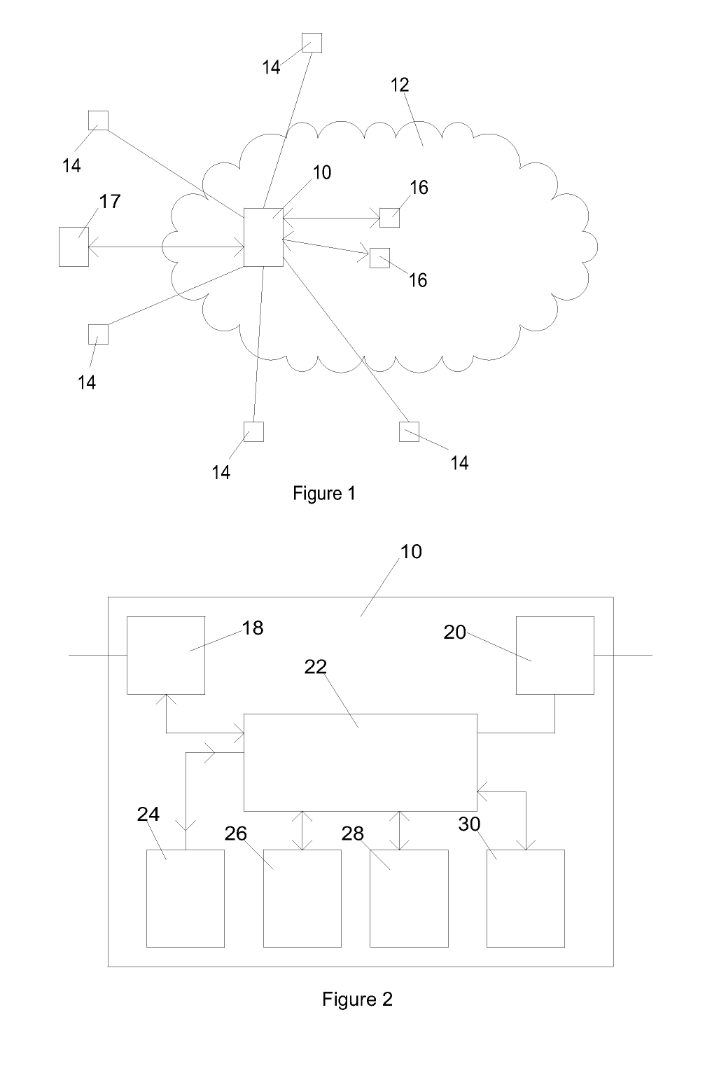

Attention is first drawn to FIG. 1, a schematic block diagram illustrating one environment within which the invention can function.

An auction server 10 in the Internet 12 or any other suitable network can be accessed by any one of a plurality of user terminals 14. The network 12 is not restricted to being the Internet 12, but can be any other type of network which allows user terminals 14 to access an auction server 10 therein, and can also include, but is not limited to, a Large Area Network (LAN), a wireless network, and a wide Area Network (WAN). The user terminals 14 can be of many different kinds, and can include, but are not limited to: personal computers connectable to the auction server 10 using cable, wire or optical connection; and wirelessly connected terminals such as mobile telephone devices, laptop, notebook and palmtop computing devices, and digital assistants.

The auction server 10 is connectable, through the Internet 12, to one or more financial sites 16 which cab include, but are not limited to: Paypal®, Iridium® and any other secure payment facility; banks; and credit card companies. The auction server 10 is operable to verify a user's credentials on signup, to obtain payment from users of user terminals 14 as they bid, and to refund to users of user terminals 14, all as part of the auction process, which is explained hereafter.

A webmaster terminal 17 is interactively connectable though the internet 12 to the auction server 10 by which images and details of items for sale can be uploaded from the webmaster terminal 17 to the auction server 10 and reports and other information downloaded from the auction server 10 to the webmaster terminal 17.

Attention is next dawn to FIG. 2, a schematic block diagram showing exemplary contents of an auction server 10 of FIG. 1.

The auction server 10 comprises first communication means 18, second communication means 20, and a controlling processor 22. The first communication means 18 maintains access with the user terminals 14 and is operable, among many other processes, too numerous to list, to perform at least one, some or all of: accepting signup information from individual user terminals 14; indicating success or failure of signup to individual user terminals 14; accepting requests to view items on which to bid from user terminals 14; accepting search requests from user terminals 14 and displaying results for item selection; accepting bids from user terminals 14; accepting request for refund from individual user terminals 14; providing images and current global bidding information to all interested user terminals 14 for a particular item; providing a particular user terminal 14 information relating to financial status of the respective user terminal 14; and indicating bid success or failure to individual user terminals 14.

The second communication means 20 provides interactive communication with the one or more financial sites 16. As will be described here after, the financial sites 16 are employed by the auction server 10 to perform at least one, some or all of: verifying status of a signup user from a user terminal 14; accepting and paying payment of funds to the auction server 10; and refunding user funds back to the user at a user terminal.

The webmaster terminal 17 is also operable to use one, the other or both of the first 18 and second 20 communication means, or a quite separate communication means, to upload images and details of items for sale to the auction server 10 and to receive reports from the auction server 10.

FIG. 2 shows merely an exemplary view of the auction server 10, and the first 18 and second 20 communication means can be one and the same, and can also be as many different communication means as are required to perform the function of the invention as described and claimed.

The controlling processor 22 is the controlling heart of the auction server 10 and serves to control and co-ordinate all of the activities of the auction server 10 as set out hereafter.

The auction processor 10 also comprises necessary memory elements. A user memory 24 retrievably stores user information relating to, but not limited to: individual user sign-on passwords and names; individual user financial source details; and individual user current bid amounts; and individual user refund status.

The auction processor 10 also comprises an auction item memory 26 which accepts images of items for auction and details such as a target price, all of which are provided by the webmaster terminal 17 to the auction server 10.

The auction processor 10 also comprises a calculation memory 28 employed by the controlling processor 22 when determining the total amount an individual bidder has bid for a particular item and if the total amount bid for an individual item an individual bidder has exceeded a target sales price.

The auction server 10 also comprises programme and operating memories 30 for use with and by the controlling processor 22 as it performs the actions required for operation of the auction server 10. FIG. 2 is only an exemplary view of the contents of the auction server 10, and each of the different memories 24 26 28 mentioned, as well as the programme and operating memories 30, can be a separate memory of can be a partition of a general memory used by the controlling processor 22.

The auction server 10 has been thus far described as a separate unique server site. It is to be appreciated that the auction server 10 can also be embodied as a so-called cloud of auction sites (not shown) where a plurality of interactive internet 12 sites can co-operate with each other to perform the function hereafter and herein before ascribed to the auction server 10.

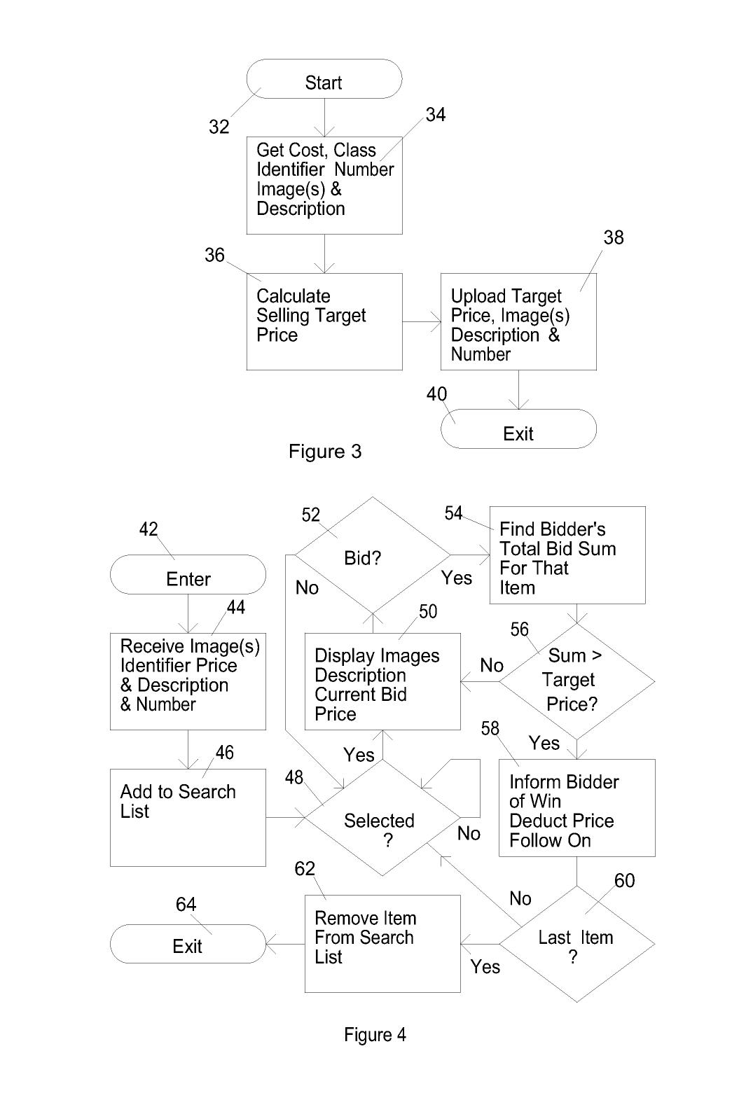

Attention is next drawn to FIG. 3, a flow chart illustrating the activity of the webmaster terminal 17 when presenting an item for sale to the auction server 10.

From a start 32 a first operation 34 accepts a humanly prepared or otherwise downloaded image and description of an item that is to be presented for auction together with the total number of that item which are presented for sale on this occasion. The first operation also receives an indication of the cost paid by the operator of the action site for the item to be sold. The webmaster terminal 17 allocates or receives an item identifier alphanumeric sequence by which the auction server 10 can keep track of the item during the auction and bidding process and which can be used by the auction server 10 to identify the item when making reports back to the webmaster terminal 17. The webmaster terminal 17 also receives a humanly or automatically provided indication of to which of a plurality of classes of goods the particular item for presentation for sale belongs.

A second operation 36 then calculates a target selling price for the item in question. One or more markup percentages are provided dependent upon the classification of the goods in question. The second operation 36 applies the indicated markup for the particular classification to the price paid for each example of that item, together with optional handling or other associated costs which may be added at this stage, to arrive at a target selling price for each example of that item.

A third operation 38 then uploads the target selling price, image(s), description and number of items to be sold to the auction server 10. Exit is then made by exit 40.

It is to be understood that the target price calculation of the second operation 36 can, instead, be performed in the auction server 10.

Attention is next drawn to FIG. 4, an exemplary flow chart showing one example of how the auction server 10 can handle the presentation and sale of a particular item. It is to be understood that FIG. 4 relates only to one single item for sale, and that the auction server 10 is capable simultaneously to handle the presentation and sale of a plurality of items.

From an entry 42 a fourth operation 44 receives from the webmaster terminal 17, the image(s) associated with the particular item for sale, the description, the number of that item presented for sale at that time, and the target selling price. A fifth operation 46 then adds the information as an entry into a search list, stored in the auction item memory 26, which can be accessed in a search from the user terminals 14.

A first test 48 waits until the particular item for sale is selected from a search and passes control to a sixth operation 50 which displays to the user of the respective searching user terminal 14 the image(s) and description of the item, together with the current bid price.

It is to be noted that neither the target selling price nor the number of items for sale on this occasion is displayed. The potential bidder is unaware of what is the “winning” target price, so is unable to know what single bid to make.

A second test 52 then checks to see if the user of the searching user terminal 14 has made a bid for the item. If the user has not made a bid, control is returned to the first test 48. If the user makes a bid, control passes to a seventh operation 54 adds the user's bid to the total bids made by the user for that item and a third test 56 checks to see if the sum of the bids made by that bidder for that item has equaled or exceeded the target selling price.

If a the sum of the bidders bids made for that particular item has not exceeded the target selling price, the seventh operation third test 56 passes control back to the sixth operation 60 which, as is explained below, instead of the current bid price displayed when the bidder made their bid, is a current bid price incremented by a predetermined amount, the amount being set by the auction server 10, or being uploaded from the webmaster terminal 17 or each item.

Each time a bidder bids on the item, the bidder is allowed to bid up the price by just one predetermined increment of currency amount over the current bid price, preferably a small predetermined amount, thereby retaining the attention, keenness and interest of bidders, the predetermined increment, in this example, being just one unit of currency, preferable just one dollar. If the bid is accepted, but the item is still not “won”, the indicated current bid price is incremented by the predetermined increment in currency. The indicated current bid price thus increments, on each occasion of a bid being placed, by just one predetermined amount.

Each time a bidder makes a bid, the amount of that bid is paid, using one or more of the financial sites 18, to the control of the auction server 10, so that the sum of the amounts bid by that bidder on that item is actually held by the auction site 10, thereby avoiding the problem of subsequent non-payment by a bidder, a problem encountered in many other types of auction website operation.

When each bidder bids on that item, the amount of the bid, together with the sum of any other bids that bidder may have made on that item, is added to the total amount bid by that bidder for that item. The total amount bid by each bidder thereby leaps in ever greater increments as bidding progresses for the particular item.

If the third test 56 finds that the sum of the bidder's bids for that particular item has exceeded to target selling price, an eighth operation 58 informs that bidder that he has won the item, deducts the target selling price from the total amount bid in that item by the bidder, and credits the bidders account with the difference between the target selling price and the total amount bid on that item by the bidder. This difference amount can be allocated by the bidder against other items for which they may wish to bid. The eighth operation 58 also initiates the follow on where, for example, the item is dispatched to the bidder's nominated address.

Although the winning bidder has completed his sale, no other bidder is aware that winning bidder has won their bid, nor is any bidder, including the winning bidder, aware of how many examples of that item are provided for sale on that occasion. No other bidder knows if, if they made a bid, that they will win. A winning bidder may have made many low value bids whose total sum exceeded the target selling price. A high bid bidder may not have a sufficient sum of bids to exceed the target selling price despite the relatively large amounts of each bid. The uncertainty of winning an item on a bid and the uncertainty that all of the items might not be sold before a winning bid can be made lends to the anxiety and excitement of a true auction site and to the adrenal reaction encountered in gambling while at the same time avoiding gambling and ensuring the financial safety of the participants by arranging that every winning bidder receives value for money.

A fourth test 60 then checks against the number of items offered for sale on this occasion to see if the item just won by the winning bidder was the last of that item offered for sale. If it was not, the fourth test 60 passes control back to the first test 48 which waits for the item again to be selected from a search by a user terminal 14 operator.

If the fourth test 60 finds that the item just won was the last of that item offered for sale on that occasion, a ninth operation 62 removes the item from the search list, informs each of the bidders that the item has been sold out, and informs the webmaster terminal 17 that the sale of that item is over.

The process for that item is ended by an exit 64. All of the processes of the auction server 10 are either automatically performed or are of an automatically set value for selection, or not, by a user, once the initial information is received by the auction server 10 from the webmaster terminal 17, and provide the business and operational advantages earlier stated. The auction process allows a valid value-for-money sale to be made while encouraging the entertainment value of an auction or gambling site.

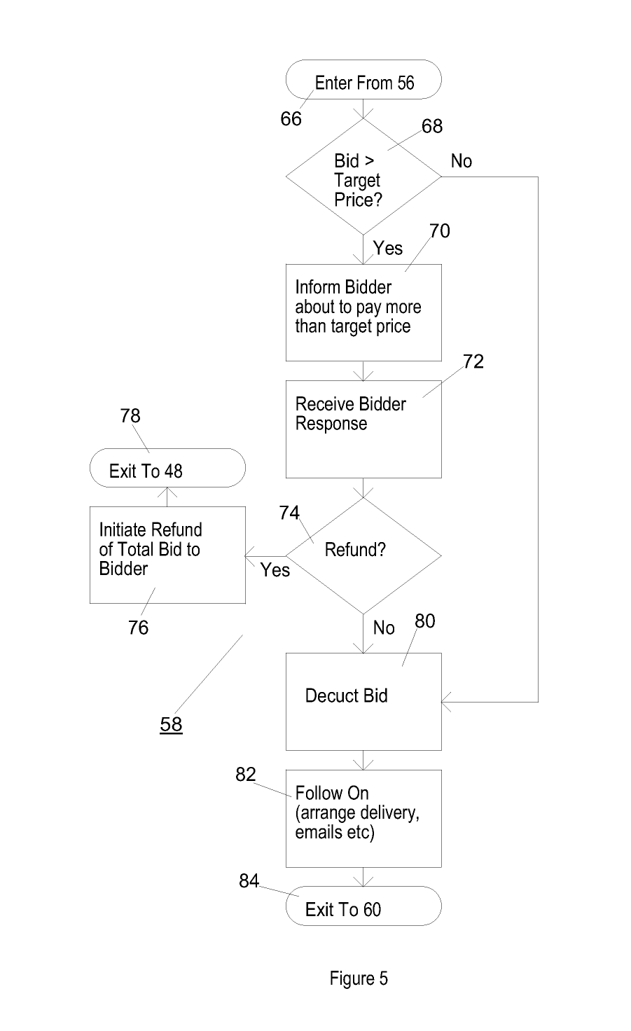

Attention is next drawn to FIG. 5, a flow chart illustrating one way in which the eighth operation 58 of FIG. 4 can be implemented.

The eighth operation 58 commences with an entry 66 from the third test 65. A fifth test 68 then checks to see if the amount bid by the potentially winning bidder exceeds the target selling price. The target selling price represents a fair price markup, for example, 25% plus postage and packing, for the item. If the bidder still wishes to pay the amount they have bid, it indicates that nonetheless the bidder accepts the deal.

If the fifth test 68 finds the bid exceeds the target selling price, a tenth operation 70 informs the bidder that the amount he has bid in total for that item exceeds a predetermined selling price and how much the bidder has bid in total. It is preferred that the tenth operation does not inform the bidder of by how much the total of amounts bid exceeds the target selling price, so that the target selling price remains uncertain. The tenth operation also informs the bidder that the bidder may continue to complete the sale or can drop out of the sale and obtain a refund of the total amount the bidder has bid in that auction. An eleventh operation 72 then waits to receive the bidder's response.

If a sixth test 74 detects that the bidder wishes to pull out of the sale, indicating that the bidder is no longer interested in receiving the item or that, in the bidder's estimation, the total amount to be paid is too great, a twelfth operation 76 initiates paying a refund to the bidder of the total amount bid and paid by the bidder for that item using the financial sites 18 of FIG. 1, typically by a bidder Paypal® account of an Iridium® account, the refund taking up to 5 days. The eighth operation 58 then exits via an exit 78 to the first test 48 of FIG. 4 to await selection of the item for another possible bid.

If the sixth test 74 detects that the bidder is content to proceed with the sale at the total amount bid, a thirteenth operation 80 deducts the total amount bid from the bidder's account by way of accepting payment, and a fourteenth operation 82 initiates the follow on to the sale for example, arranging shipping to the bidder, sending emails to the bidder, and all of the actions customary in an auction when an item has been sold to a bidder.

The eighth operation 58 then ends by way of exit 84 to the fourth test 60 of FIG. 4 which checks to see if the particular item sold is the last item offered for sale on this occasion.

In the above manner, no bidder is required to pay for an item they no longer want, or for any item that the bidder considers too expensive. Further, the above arrangement ensures that every item sold is with the full agreement of the bidder.

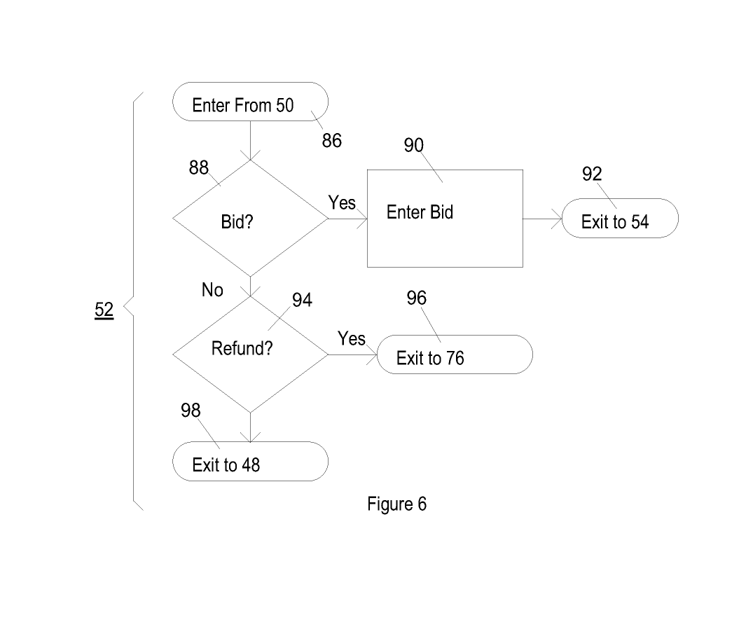

Attention is next drawn to FIG. 6, an exemplary flowchart illustrating one way in which the second test 52 of FIG. 4 can be implemented to enable a bidder to obtain a refund of the total amount bid at any stage during the course of an auction for an item.

The second test 52 commences with an entry 86 from the sixth operation 50 of FIG. 4. A seventh test 88 detects whether of not the user of a user terminal 14 wishes to bid on the item. If the user of the user terminal 14 wishes to bid on the item, a fifteenth operation 90 accepts the bid and the second test 52 is left by an exit 92 to the seventh operation 54 shown in FIG. 4.

If the seventh test 88 does not detect that the user of the user terminal 14 wishes to make a bid, a eighth test 94 detects whether the user of the user terminal 14 wishes for a refund of the total they have bid for the item so far. The bidder is also offered the possibility of ‘banking’ their funds to use at a later date on the same item or to transfer it to another item, leaving the funds in their membership account. If eighth test 94 detects requirement for a refund, the second test 52 is exited by an exit 96 to the twelfth operation 76 shown in FIG. 5 where a refund is initiated.

If the use of the user terminal requires neither to bid nor to obtain a refund, the second test is exited via exit 98 to the first test 48 shown in FIG. 4.

By this procedure, a bidder can obtain a refund of the total amount thus far bid on an item at any stage during the bidding process.

The invention has been described so far in terms of particular examples whereby the invention can be implements. It is to be appreciated that the skilled man would be aware of many different variants and other examples whereby the invention can be put into practise within the spirit of the invention as described and claimed.

The invention is further made clear, explained and defined by the following claims.

1. An system comprising an auction server for auctioning an tem and a network through which one or more bidders can make a bid for the item, the item being provided with a target price; where:
the auction server comprises means automatically operable to receive a bid from a bidder;
the auction server comprises means automatically operable to add the latest bid from that bidder to the sum of any earlier bids from that bidder for that item to make a total bid; and
the auction server comprises means automatically operable to carry out a winners procedure for a bidder for the item when the total bid for that item made by that bidder exceeds the target price.

2. The system, according to claim 1, wherein the auction server comprises means to hold a current bid price for the item; and wherein the auction server comprises means, automatically operable to receive, as a fresh bid, only an amount which exceeds the current bid price by a predetermined amount.

3. The system, according to claim 2, wherein the auction server comprises means automatically operable to collect the amount bid from a bidder on each occasion that the bidder places a bid for that item.

4. The system, according to claim 3, comprising mean, operable in response to indication by the bidder, to accept the sale even if the total bid by that bidder is greater than the target price.

5. The system, according to claim 4, wherein the auction server comprises means, automatically operable at any stage of the bidding process to receive and to respond to a request by bidder, to deliver a refund of the total bid by that bidder to that bidder.

6. The system, according to claim 1 wherein the item is one of a plurality of like items offered for sale at the same time, the auction server comprising means operable to sell each of the like items in turn until the last like item has been won.

7. The system, according to claim 2 wherein the item is one of a plurality of like items offered for sale at the same time, the auction server comprising means operable to sell each of the like items in turn until the last like item has been won.

8. The system, according to claim 3 wherein the item is one of a plurality of like items offered for sale at the same time, the auction server comprising means operable to sell each of the like items in turn until the last like item has been won.

9. The system, according to claim 4 wherein the item is one of a plurality of like items offered for sale at the same time, the auction server comprising means operable to sell each of the like items in turn until the last like item has been won.

10. The system, according to claim 5 wherein the item is one of a plurality of like items offered for sale at the same time, the auction server comprising means operable to sell each of the like items in turn until the last like item has been won.

11. A method of conducting an auction for an item; the method comprising the steps of:
a step of setting a target price for the item;
a step of automatically receiving a bid from a bidder;
a step of automatically adding the latest bid from that bidder to the sum of any earlier bids from that bidder for that item to make a total bid;
and
a step of automatically carrying out a winners procedure for a bidder for the item when the total bid for that by that bidder item exceeds the target price.

12. The method, according to claim 11, including:
a step of holding a current bid price for the item; and
a step of automatically receiving, as a fresh bid, only an amount which exceeds the current bid price by a predetermined amount.

13. The method, according to claim 12, including the step of automatically collecting the amount bid from a bidder on each occasion that the bidder places a bid for that item.

14. The method, according to claim 13, including the step of responding to indication by the bidder, to accept the sale even if the total bid by that bidder is greater than the target price.

15. The method, according to claim 14, including the step of, at any stage of the bidding process, of receiving and responding to a request by bidder, to deliver a refund of the total bid by that bidder to that bidder.

16. The method, according to claim 11 wherein the item is one of a plurality of like items offered for sale at the same time, the method including the step selling each of the like items in turn until the last like item has been won.

17. The method, according to claim 12 wherein the item is one of a plurality of like items offered for sale at the same time, the method including the step selling each of the like items in turn until the last like item has been won.

18. The method, according to claim 13 wherein the item is one of a plurality of like items offered for sale at the same time, the method including the step selling each of the like items in turn until the last like item has been won.

19. The method, according to claim 14 wherein the item is one of a plurality of like items offered for sale at the same time, the method including the step selling each of the like items in turn until the last like item has been won.

20. The method, according to claim 15 wherein the item is one of a plurality of like items offered for sale at the same time, the method including the step selling each of the like items in turn until the last like item has been won.
